(19) United States
(12) Patent Application Publication
(10) Pub. No.: US 2012/0008030 A1
(43) Pub. Date: Jan. 12, 2012

(54) SOLID-STATE IMAGING APPARATUS AND IMAGING SYSTEM

(75) Inventors: Shoji Kono, Hachioji-shi (JP); Yuichiro Yamashita, Ebina-shi (JP); Masaru Fujimura, Yokohama-shi (JP); Shin Kikuchi, Isehara-shi (JP); Shinichiro Shimizu, Yokohama-shi (JP); Yu Arishima, Yokohama-shi (JP); Takeshi Kojima, Kawasaki-shi (JP)

(73) Assignee: CANON KABUSHIKI KAISHA, Tokyo (JP)

(21) Appl. No.: 13/174,822

(22) Filed: Jul. 1, 2011

(30) Foreign Application Priority Data
Jul. 7, 2010 (JP) 2010-155262
Jun. 21, 2011 (JP) 2011-136973

(51) Int. Cl. H04N 5/335

(52) U.S. Cl. 348/301; 348/E05.091

(57) ABSTRACT

A solid-state imaging apparatus including a plurality of pixels each having a photoelectric conversion element, and an amplifier circuit which amplifies and outputs signals of the plurality of pixels is provided. The plurality of pixels include a first pixel having a first photoelectric conversion element with a first sensitivity and a second pixel having a second photoelectric conversion element with a second sensitivity higher than the first sensitivity. The amplifier circuit amplifies a signal output from the first pixel by a first gain and a signal output from the second pixel by a second gain smaller than the first gain.

### BACKGROUND OF THE INVENTION

1. Field of the Invention

The present invention relates to a solid-state imaging apparatus and an imaging system.

2. Description of the Related Art

Sensor panels used in solid-state imaging apparatuses are becoming large in recent years. Along with the upsizing of sensor panels, a technique of tiling a plurality of imaging blocks to implement a large-sized sensor panel has come into general use. Several problems are known to arise when bonding the plurality of imaging blocks. In Japanese Patent Laid-Open No. 2002-90462, line defects are problematic, which are caused by tiling imaging blocks with scanning circuits and the like arranged at the periphery of the pixel array. In this reference, the scanning circuits and the like are arranged in unit cells to solve the problem, as shown in FIG. 7 of this reference. When the scanning circuits and the like are arranged in the unit cells, the area of each unit cell including the scanning circuits and the like is smaller than that of a unit cell including no scanning circuits and the like on the planar view of the photoelectric conversion elements. In Japanese Patent Laid-Open No. 2002-44522, adjacent pixels on both sides of the gap between imaging blocks is wider than the gap between adjacent pixels in an imaging block, and resultant image distortion poses a problem. In this reference, to solve the problem, the area of pixels closest to the edge of an imaging block is made smaller than that of the remaining pixels on the planar view of the photoelectric conversion elements, as shown in FIG. 7. This unifies the distances between the centers of gravity of photoelectric conversion elements across the plurality of imaging blocks.

### SUMMARY OF THE INVENTION

As described above, when the solid-state imaging apparatus includes pixels with different photoelectric conversion element areas, the sensitivity varies between the pixels. Additionally, the pixel sensitivity sometimes changes independently of the above-described arrangement. Hence, an aspect of the present invention provides a technique that reduces the sensitivity variation between pixels in a solid-state imaging apparatus including pixels whose sensitivities are different from each other.

A first aspect of the present invention provides a solid-state imaging apparatus including a plurality of pixels each having a photoelectric conversion element, and an amplifier circuit which amplifies and outputs signals of the plurality of pixels, the plurality of pixels comprising a first pixel having a first photoelectric conversion element with a first sensitivity and a second pixel having a second photoelectric conversion element with a second sensitivity higher than the first sensitivity, wherein the amplifier circuit amplifies a signal output from the first pixel by a first gain and a signal output from the second pixel by a second gain smaller than the first gain.

A second aspect of the present invention provides a solid-state imaging apparatus including a plurality of pixels each having a photoelectric conversion element and an auxiliary capacitance connected to the photoelectric conversion element to increase a capacitance value of the photoelectric conversion element, and an amplifier circuit which amplifies and outputs signals of the plurality of pixels, the plurality of pixels comprising a first pixel having a first photoelectric conversion element with a first sensitivity and a second pixel having a second photoelectric conversion element with a second sensitivity higher than the first sensitivity, wherein a capacitance value of the auxiliary capacitance connected to the first photoelectric conversion element is smaller than a capacitance value of the auxiliary capacitance connected to the second photoelectric conversion element.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIGS. 1A and 1B explain an example of the schematic arrangement of a solid-state imaging apparatus according to an embodiment of the present invention;

FIG. 2 explains an example of the arrangement of an imaging block according to the embodiment of the present invention;

FIG. 3 explains an example of the arrangement of a pixel according to the embodiment of the present invention;

FIGS. 4A and 4B explain an example of the arrangements of shift registers according to the embodiment of the present invention;

FIG. 5 explains an example of a timing chart according to the embodiment of the present invention;

FIG. 6 explains two types of unit cells according to the embodiment of the present invention;

FIG. 7 explains an example of the arrangement of a pixel according to another embodiment of the present invention;

FIG. 8 explains two types of photoelectric conversion elements according to still another embodiment of the present invention;

FIG. 9 explains two types of photoelectric conversion elements according to still another embodiment of the present invention;

FIG. 10 explains an example of the arrangement of an imaging block according to yet another embodiment of the present invention;

FIG. 11 explains an example of the arrangement of an imaging block according to another embodiment of the present invention.

FIG. 12 explains a radiation imaging system according to an embodiment of the present invention.

### DESCRIPTION OF THE EMBODIMENTS

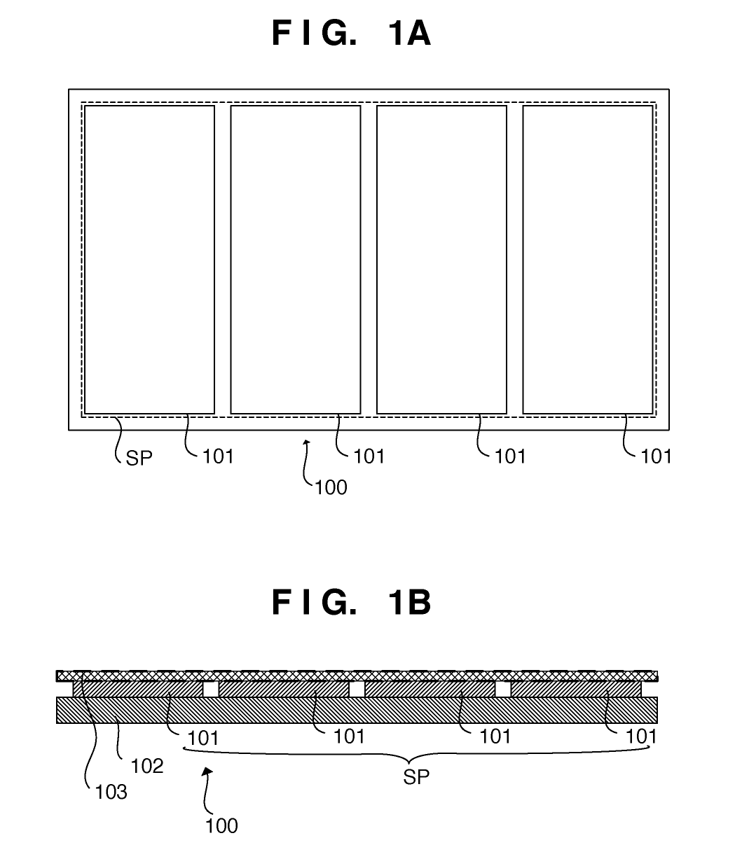

The schematic arrangement of a solid-state imaging apparatus 100 according to an embodiment of the present invention will be described with reference to FIGS. 1A and 1B. The solid-state imaging apparatus 100 can be formed by, for example, arraying a plurality of imaging blocks 101. In this case, an array of a plurality of imaging blocks 101 can form a sensor panel SP having one imaging region. The plurality of imaging blocks 101 can be arranged on a support substrate 102. When the solid-state imaging apparatus 100 uses a single imaging block 101, the single imaging block 101 forms the sensor panel SP. Each of the plurality of imaging blocks 101 may be provided by, for example, forming a circuit element on a semiconductor substrate or forming a semiconductor layer on, for example, a glass substrate and forming a circuit element on the semiconductor layer. Each of the plurality of imaging blocks 101 has a pixel array in which a plurality of pixels are arrayed so as to form pluralities of rows and columns.

The solid-state imaging apparatus 100 may serve as an apparatus which captures an image of radiation such as X-rays or an apparatus which captures an image of visible light. When the solid-state imaging apparatus 100 serves as an apparatus which captures an image of radiation, a scintillator 103 which converts radiation into visible light can typically be provided on the sensor panel SP. The scintillator 103 converts radiation into visible light, which strikes the sensor panel SP and is photoelectrically converted by each photoelectric conversion element on the sensor panel SP (imaging block 101).

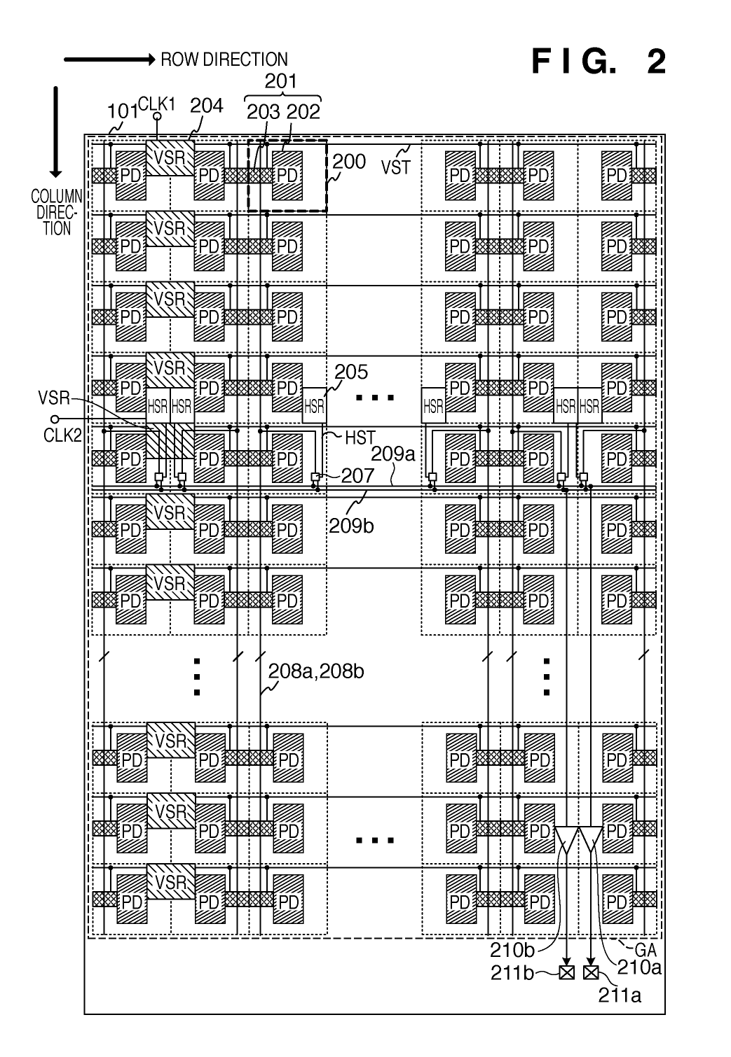

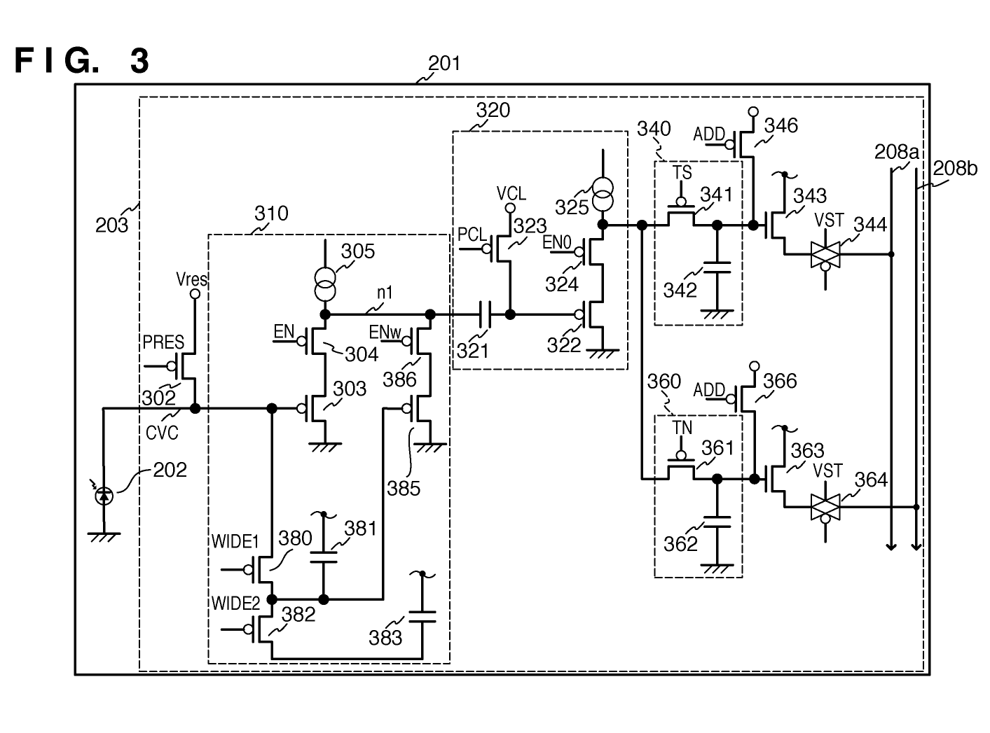

An example of the arrangement of each imaging block 101 will be described next with reference to FIG. 2. When the solid-state imaging apparatus 100 uses a single imaging block 101, the single imaging block 101 can be regarded as a solid-state imaging apparatus. The imaging block 101 has a pixel array GA in which a plurality of pixels 201 are arrayed so as to form pluralities of rows and columns and a plurality of column signal lines 208a are arranged. Each of the plurality of pixels 201 includes a photoelectric conversion element (for example, a photodiode) 202, and an in-pixel readout circuit 203 which outputs a signal (light signal) corresponding to a charge generated by the photoelectric conversion element 202 to the column signal line 208a. In the pixel array GA, a plurality of column signal lines 208b may further be arranged, and the in-pixel readout circuit 203 can be configured to output noise generated by itself to the column signal line 208b in this case. In-pixel readout circuits 203 of two adjacent pixels 201 aligned in the row direction can be axisymmetrically arranged to have, for example, the boundary line between the two pixels 201 as their symmetry axis.

The imaging block 101 includes vertical scanning circuits 204 and horizontal scanning circuits 205. Although the vertical scanning circuit 204 can be placed, for example, between the photoelectric conversion elements 202 on two adjacent columns, it may be placed outside the photoelectric conversion element 202 on the outermost column in the pixel array GA. The vertical scanning circuit 204 includes, for example, a vertical shift register which performs a shift operation in accordance with a first clock CLK1, and scans a plurality of rows in the pixel array GA in accordance with the shift operation by the vertical shift register. The vertical shift register is formed by connecting a plurality of registers in series, and a pulse received by a register in the first stage is sequentially transferred to registers in subsequent stages in accordance with the first clock CLK1. A row corresponding to a register which holds a pulse is to be selected.

Although the horizontal scanning circuit 205 can be placed, for example, between the photoelectric conversion elements 202 on two adjacent rows, it may be placed outside the photoelectric conversion element 202 on the outermost row in the pixel array GA. The horizontal scanning circuit 205 includes, for example, a horizontal shift register which performs a shift operation in accordance with a second clock CLK2, and scans a plurality of columns in the pixel array GA in accordance with the shift operation by the horizontal shift register. The horizontal shift register is formed by connecting a plurality of registers in series, and a pulse received by a register in the first stage is sequentially transferred to registers in subsequent stages in accordance with the second clock CLK2. A column corresponding to a register which holds a pulse is to be selected.

The vertical scanning circuit 204 can be formed by vertically arraying a plurality of unit vertical scanning circuits VSR each including one register that constitutes the vertical shift register. Each unit vertical scanning circuit VSR can be placed in the region sandwiched by a photoelectric conversion element 202 of a pixel belonging to a given column (the leftmost column (that is, the first column) in FIG. 2) and a photoelectric conversion element 202 of a pixel belonging to a column adjacent to the given column (the second column from the left (that is, the second column) in FIG. 2). When a pulse is transferred via the vertical shift register, each unit vertical scanning circuit VSR drives a row select signal VST to active level so that pixels 201 on a row to which it belongs are selected. A light signal and noise from the pixel 201 on the selected row are output to the column signal lines 208a and 208b, respectively. Referring to FIG. 2, the column signal lines 208a and 208b are indicated by a single line. Pulse signals (start pulses) PULSE1 and PULSE2 are supplied to the input terminals (not shown) of the vertical scanning circuit 204 and horizontal scanning circuit 205, respectively.

The horizontal scanning circuit 205 can be formed by horizontally arraying a plurality of unit horizontal scanning circuits HSR each including one register that constitutes the horizontal shift register. Each unit horizontal scanning circuit HSR is placed in the region sandwiched by two photoelectric conversion elements 202 in each pair of two adjacent pixels (a pair of pixels on the first and second columns, a pair of pixels on the third and fourth columns, . . . ) belonging to one row (the fourth row from the top (that is, the fourth row) in FIG. 2). However, each unit horizontal scanning circuit HSR is not placed in the region sandwiched by two photoelectric conversion elements 202 in two adjacent pixels aligned in the column direction. This arrangement is advantageous to reduce the gap between the photoelectric conversion elements 202 in the column direction. When a pulse is transferred via the horizontal shift register, each unit horizontal scanning circuit HSR controls a switch 207 so that a column to which it belongs is selected, that is, the column signal lines 208a and 208b on this column are connected to horizontal signal lines 209a and 209b, respectively. That is, a light signal and noise from the pixel 201 on the selected row are output to the column signal lines 208a and 208b, respectively, and signals from the selected column (that is, the selected column signal lines 208a and 208b) are output to the horizontal signal lines 209a and 209b. This implements X-Y addressing. The horizontal signal lines 209a and 209b are connected to the inputs of output amplifiers 210a and 210b, respectively, and signals output to the horizontal signal lines 209a and 209b are amplified by the output amplifiers 210a and 210b, respectively, and output via pads 211a and 211b, respectively.

The pixel array GA can be regarded as being obtained by arraying a plurality of unit cells 200 each including the pixel 201 so as to form pluralities of rows and columns. The unit cells 200 can include several types. A certain unit cell 200 includes at least part of the unit vertical scanning circuit VSR. Although a set of two unit cells 200 includes only one unit vertical scanning circuit VSR in the example shown in FIG. 2, one unit cell 200 may include one unit vertical scanning circuit VSR or a set of three or more unit cells 200 may include one unit vertical scanning circuit VSR. Another unit cell 200 includes at least part of the unit horizontal scanning circuit HSR. Although one unit cell 200 includes one unit horizontal scanning circuit HSR in the example shown in FIG. 2, a set of a plurality of unit cells 200 may include one unit vertical scanning circuit VSR. Still another unit cell 200 includes both at least part of the unit vertical scanning circuit VSR and at least part of the unit horizontal scanning circuit HSR. Still another unit cell 200 includes, for example, a unit cell including at least part of the output amplifier 210a, a unit cell including at least part of the output amplifier 210b, and a unit cell including the switch 207.

An example of the arrangement of each pixel 201 will be described with reference to FIG. 3. The pixel 201 includes the photoelectric conversion element 202 and in-pixel readout circuit 203, as described earlier. The photoelectric conversion element 202 can typically be a photodiode. The in-pixel readout circuit 203 can include, for example, a first amplifier circuit 310, a clamp circuit 320, a light signal sample-and-hold circuit 340, and a noise sample-and-hold circuit 360, and NMOS transistors 343 and 363 and row select switches 344 and 364 in a second amplifier circuit.

The photoelectric conversion element 202 includes a charge storage unit, which is connected to the gate of a PMOS transistor 303 of the first amplifier circuit 310. The source of the PMOS transistor 303 is connected to a current source 305 via a PMOS transistor 304. A first source follower circuit is formed using the PMOS transistor 303 and current source 305. Forming a source follower circuit using the PMOS transistor 303 is effective in reducing 1/f noise. The PMOS transistor 304 serves as an enable switch which enables the first source follower circuit upon being turned on when an enable signal EN supplied to its gate changes to active level. The first amplifier circuit 310 outputs a signal corresponding to the potential of a charge/voltage conversion unit CVC to an intermediate node n1.

In the example shown in FIG. 3, the charge storage unit of the photoelectric conversion element 202 and the gate of the PMOS transistor 303 form a common node, which functions as the charge/voltage conversion unit CVC which changes a charge stored in the charge storage unit to a voltage. That is, the charge/voltage conversion unit CVC has the voltage V (=Q/C) determined by the charge Q stored in the charge storage unit and the capacitance value C of the charge/voltage conversion unit CVC. The charge/voltage conversion unit CVC is connected to a reset potential Vᵣₑₛ via a PMOS transistor 302 serving as a reset switch. When a reset signal PRES changes to active level, the PMOS transistor 302 is turned on, so the potential of the charge/voltage conversion unit CVC is reset to the reset potential Vᵣₑₛ.

The clamp circuit 320 uses a clamp capacitance 321 to clamp noise output to the intermediate node n1 by the first amplifier circuit 310 in accordance with the reset potential of the charge/voltage conversion unit CVC. In other words, the clamp circuit 320 is a circuit for canceling that noise from a signal output from the first source follower circuit to the intermediate node n1 in accordance with the charge generated by the photoelectric conversion element 202. The noise output to the intermediate node n1 contains kTC noise produced upon resetting. Clamping is done by changing a clamp signal PCL to active level to turn on a PMOS transistor 323, and thereupon changing the clamp signal PCL to inactive level to turn off the PMOS transistor 323. The output terminal of the clamp capacitance 321 is connected to the gate of a PMOS transistor 322. The source of the PMOS transistor 322 is connected to a current source 325 via a PMOS transistor 324. A second source follower circuit is formed using the PMOS transistor 322 and current source 325. The PMOS transistor 324 serves as an enable switch which enables the second source follower circuit upon being turned on when an enable signal EN0 supplied to its gate changes to active level.

A signal output from the second source follower circuit in accordance with the charge generated by photoelectric conversion by the photoelectric conversion element 202 is written in a capacitance 342 as a light signal via a switch 341 when a light signal sampling signal TS changes to active level. A signal output from the second source follower circuit upon turning on the PMOS transistor 323 immediately after the potential of the charge/voltage conversion unit CVC is reset is noise. This noise is written in a capacitance 362 via a switch 361 when a noise sampling signal TN changes to active level. This noise contains the offset component of the second source follower circuit.

When the unit vertical scanning circuit VSR of the vertical scanning circuit 204 drives the row select signal VST to active level, a signal (light signal) held in the capacitance 342 is output to the column signal line 208a via the NMOS transistor 343 and row select switch 344 in the second amplifier circuit. At the same time, a signal (noise) held in the capacitance 362 is output to the column signal line 208b via the NMOS transistor 363 and row select switch 364 in the second amplifier circuit. The NMOS transistor 343 in the second amplifier circuit and a constant current source (not shown) provided on the column signal line 208a form a source follower circuit. Similarly, the NMOS transistor 363 in the second amplifier circuit and a constant current source (not shown) provided on the column signal line 208b form a source follower circuit.

The pixel 201 may include an add switch 346 which adds light signals from a plurality of adjacent pixels 201. In an add mode, an add mode signal ADD changes to active level, so the add switch 346 is turned on. Thus, the add switch 346 connects the capacitances 342 of adjacent pixels 201 to each other, thereby averaging the light signals. Similarly, the pixel 201 may include an add switch 366 which adds noise signals from a plurality of adjacent pixels 201. When the add switch 366 is turned on, the add switch 366 connects the capacitances 362 of adjacent pixels 201 to each other, thereby averaging the noise signals.

The pixel 201 may have a function for changing the sensitivity. The pixel 201 can include, for example, a first sensitivity change switch 380, a second sensitivity change switch 382, and a circuit element associated with them. When a first change signal WIDE1 changes to active level, the first sensitivity change switch 380 is turned on, so the capacitance value of a first additional capacitance 381 is added to that of the charge/voltage conversion unit CVC. This lowers the sensitivity of the pixel 201. When a second change signal WIDE2 changes to active level, the second sensitivity change switch 382 is turned on, so the capacitance value of a second additional capacitance 383 is added to that of the charge/voltage conversion unit CVC. This further lowers the sensitivity of the pixel 201.

In this manner, adding a function of lowering the sensitivity of the pixel 201 makes it possible to receive a larger amount of light, thus widening the dynamic range. When the first change signal WIDE1 changes to active level, an enable signal EN_{W} may be changed to active level to enable a PMOS transistor 385 to perform a source follower operation, in addition to enabling the PMOS transistor 303 to perform a source follower operation.

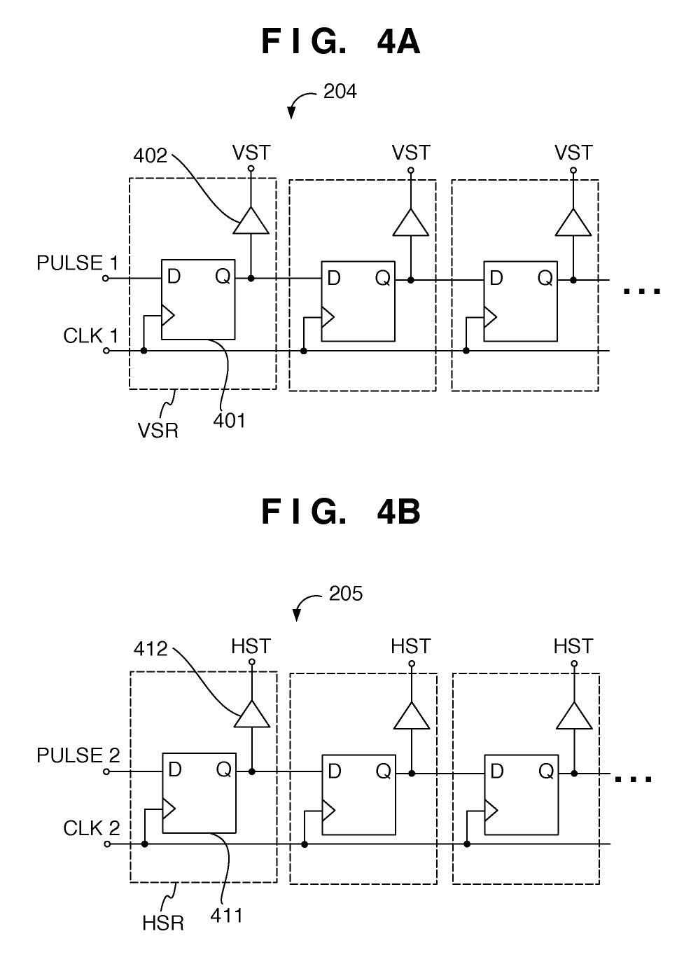

Although the vertical scanning circuit 204 can have various arrangements, it can have an arrangement shown in, for example, FIG. 4A. In the vertical scanning circuit 204 shown in FIG. 4A, each unit vertical scanning circuit VSR includes one D-type flip-flop 401, and the first clock CLK1 is supplied to the clock input of the D-type flip-flop 401. The first pulse signal PULSE1 is supplied to the D input of the D-type flip-flop 401 of the unit vertical scanning circuit VSR in the first stage, and received in response to the first clock CLK1. The D-type flip-flop 401 in the first stage outputs a pulse signal having a duration corresponding to one cycle of the first clock CLK1 from its Q output. The Q output of the D-type flip-flop 401 of each unit vertical scanning circuit VSR is used to select a row to which the unit vertical scanning circuit VSR belongs, and is output as a row select signal VST via, for example, a buffer 402. The Q output of the D-type flip-flop 401 of each unit vertical scanning circuit VSR is connected to the D input of the D-type flip-flop 401 of the unit vertical scanning circuit VSR in the next stage.

Although the horizontal scanning circuit 205 can have various arrangements, it can have an arrangement shown in, for example, FIG. 4B. In the horizontal scanning circuit 205 shown in FIG. 4B, each unit horizontal scanning circuit HSR includes one D-type flip-flop 411, and the second clock CLK2 is supplied to the clock input of the D-type flip-flop 411. The second pulse signal PULSE2 is supplied to the D input of the D-type flip-flop 411 of the unit horizontal scanning circuit HSR in the first stage, and received in response to the second clock CLK2. The unit horizontal scanning circuit HSR in the first stage outputs a pulse signal having a duration corresponding to one cycle of the second clock CLK2 from its Q output. The Q output of each unit horizontal scanning circuit HSR is used to select a column to which the unit horizontal scanning circuit HSR belongs, and is output as a column select signal HST via, for example, a buffer 412. The Q output of each unit horizontal scanning circuit HSR is connected to the D input of the D-type flip-flop 411 of the unit horizontal scanning circuit HSR in the next stage. Note that the vertical scanning period that is the scanning period of the vertical scanning circuit 204 is obtained by multiplying the horizontal scanning period of the horizontal scanning circuit 205 by the number of rows in the pixel array GA. The horizontal scanning period is the period of time required to scan all columns in the pixel array GA. Hence, the frequency of the second clock CLK2 supplied to the horizontal scanning circuit 205 which generates the column select signal HST used to select a column is greatly higher than that of the first clock CLK1 supplied to the vertical scanning circuit 204 which generates the row select signal VST used to select a row.

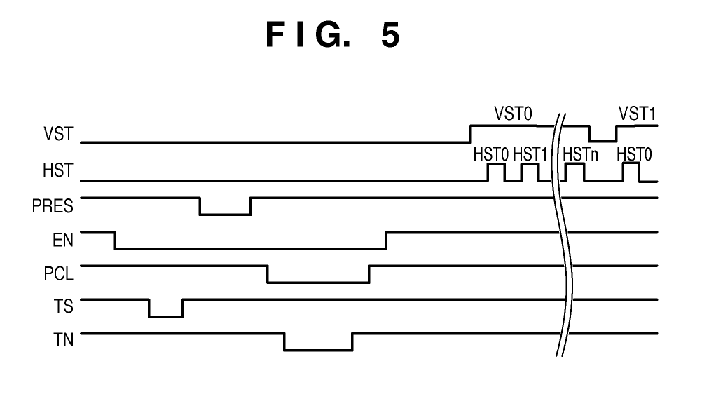

Main signals supplied to each pixel 201 will be described with reference to FIG. 5. The reset signal PRES, enable signal EN, clamp signal PCL, light signal sampling signal TS, and noise sampling signal TN are low-active signals. Although not shown in FIG. 5, the enable signal EN0 can be a signal similar to the enable signal EN. Also, although not shown in FIG. 5, the enable signal EN_{W} can make a transition in the same way as in the enable signal EN when the first change signal WIDE1 becomes active.

First, the enable signal EN becomes active on all rows in the pixel array GA, and the light signal sampling signal TS changes to active level in a pulsed pattern, so a light signal is written in the capacitance 342. Next, the reset signal PRES changes to active level in a pulsed pattern, so the potential of the charge/voltage conversion unit CVC is reset. The clamp signal PCL changes to active level in a pulsed pattern. When the clamp signal PCL is at active level, the noise sampling signal TN changes to active level in a pulsed pattern, so noise is written in the capacitance 362.

A unit vertical scanning circuit VSR corresponding to the first row of the vertical scanning circuit 204 changes its row select signal VST (VST0) to active level. This means that the vertical scanning circuit 204 selects the first row of the pixel array GA. In this state, unit horizontal scanning circuits HSR corresponding to the first to last columns of the horizontal scanning circuit 205 change their column select signals HST (HST0-HSTn) to active level. This means that the horizontal scanning circuit 205 sequentially selects the first to last columns of the pixel array GA. Thus, light signals and noise signals of pixels on the first to last columns on the first row of the pixel array GA are output from the output amplifiers 210a and 210b, respectively. After that, a unit vertical scanning circuit VSR corresponding to the second row of the vertical scanning circuit 204 changes its row select signal VST (VST1) to active level. Unit horizontal scanning circuits HSR corresponding to the first to last columns of the horizontal scanning circuit 205 change their column select signals HST (HST0-HSTn) to active level. By performing such an operation for the first to last rows, one image is output from the pixel array GA.

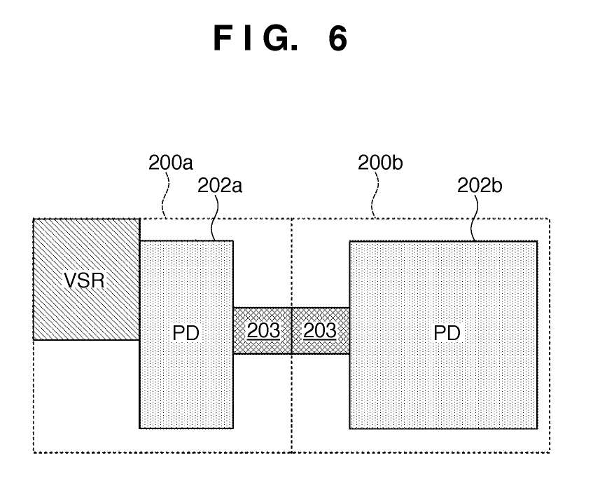

FIG. 6 places focus on, out of unit cells 200 of a pixel array GA shown in FIG. 2, a first unit cell 200a including a unit vertical scanning circuit VSR and a second unit cell 200b including neither the unit vertical scanning circuit VSR nor a unit horizontal scanning circuit HSR.

The pixel included in the first unit cell 200a is called a first pixel, and that included in the second unit cell 200b is called a second pixel. The first unit cell 200a includes the unit vertical scanning circuit VSR. A first photoelectric conversion element 202a is adjacent to the unit vertical scanning circuit VSR. On the other hand, the second unit cell 200b includes neither the unit vertical scanning circuit VSR nor the unit horizontal scanning circuit HSR. That is, a second photoelectric conversion element 202b is adjacent to neither scanning circuit. No photoelectric conversion element 202 can be overlaid in the region of the unit vertical scanning circuit VSR. Hence, the area of the first photoelectric conversion element 202a is smaller than that of the second photoelectric conversion element 202b on the planar view. For this reason, when incident light 620 irradiates the whole surface of the photoelectric conversion elements, the sensitivity of the first photoelectric conversion element 202a can be lower than that of the second photoelectric conversion element 202b. In this embodiment, the gain of an in-pixel readout circuit 203 of the first pixel and that of the in-pixel readout circuit 203 of the second pixel are adjusted, thereby reducing the sensitivity difference between the first pixel and the second pixel.

In this embodiment, the gain of the in-pixel readout circuit 203 of the second pixel whose photoelectric conversion element has a large area on the planar view is made smaller than that of the in-pixel readout circuit 203 of the first pixel whose photoelectric conversion element has a small area on the planar view. As described above, the in-pixel readout circuit 203 includes a first amplifier circuit 310, a second source follower circuit including a PMOS transistor 322, and an NMOS transistor 343 of the second amplifier circuit. The gain of the in-pixel readout circuit 203 can be adjusted by combining at least some of these amplifier circuits. When uniform incident light irradiates the first photoelectric conversion element 202a and the second photoelectric conversion element 202b, the first pixel receives the incident light in a smaller amount because the first photoelectric conversion element 202a has a smaller area. Even in this case, since the in-pixel readout circuit 203 of the first pixel has a larger gain, the difference between the voltage output from the in-pixel readout circuit 203 of the first pixel and the voltage output from the in-pixel readout circuit 203 of the second pixel is reduced. The gain of the in-pixel readout circuit 203 of each pixel may be adjusted such that the voltage output from the in-pixel readout circuit 203 of the first pixel equals that of the second pixel when uniform incident light irradiates the first photoelectric conversion element 202a and the second photoelectric conversion element 202b.

FIG. 6 places focus on the first unit cell 200a including the unit vertical scanning circuit VSR and the second unit cell 200b including no unit scanning circuit. Similarly, the unit cell 200 including the unit horizontal scanning circuit HSR or the unit cell 200 including both the unit scanning circuits in the vertical and horizontal directions also has an area smaller than that of the second unit cell 200b on the planar view of the photoelectric conversion elements. For the unit cells 200 as well, the gain of the in-pixel readout circuit 203 may be adjusted to be larger than that of the second unit cell 200b. This embodiment is generally applicable when the apparatus includes at least two types of pixels with different areas on the planar view of the photoelectric conversion elements 202. The larger the area of the photoelectric conversion element 202 of the pixel 201 becomes, the smaller the gain of the in-pixel readout circuit 203 serving as the amplifier circuit that amplifies the voltage corresponding to the charges generated in the photoelectric conversion element 202 and outputs the amplified voltage is adjusted to be.

According to this embodiment, the difference between the voltages output from the in-pixel readout circuits 203 is thus reduced for the pixels whose photoelectric conversion elements 202 have different areas on the planar view.

### Second Embodiment

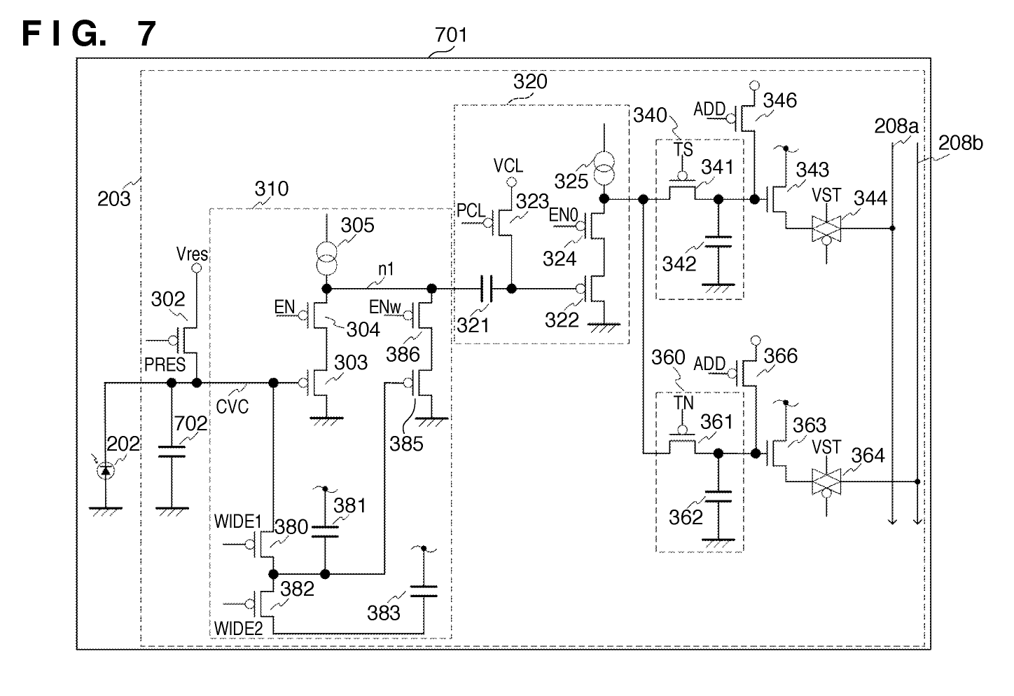

In this embodiment, a pixel 701 shown in FIG. 7 is used in place of the pixel 201 of the first embodiment. The remaining portions are the same as in the first embodiment, and a description thereof will not be repeated. The pixel 701 has an auxiliary capacitance 702. The auxiliary capacitance 702 is connected to a common node formed from the charge storage unit of a photoelectric conversion element 202 and the gate of a PMOS transistor 303. The remaining elements of the pixel 701 are the same as those of the pixel 201, and a description thereof will not be repeated.

The auxiliary capacitance 702 acts to increase the capacitance value apparent from a charge/voltage conversion unit CVC. The larger the capacitance value of the photoelectric conversion element 202 is, the smaller the voltage output from an in-pixel readout circuit 203 is. In this embodiment, the larger the area of the photoelectric conversion element 202 of the pixel 701 becomes, the larger the capacitance value of the auxiliary capacitance 702 connected to the photoelectric conversion element 202 is made. When uniform incident light irradiates a first photoelectric conversion element 202a and a second photoelectric conversion element 202b, the first pixel receives the incident light in a smaller amount because the first photoelectric conversion element 202a has a smaller area. That is, charges in a smaller amount are generated in the first pixel. Even in this case, since the capacitance value of the auxiliary capacitance 702 connected to the photoelectric conversion element 202 of the first pixel is smaller, the difference between the voltage output from the in-pixel readout circuit 203 of the first pixel and the voltage output from the in-pixel readout circuit 203 of the second pixel is reduced. The capacitance value of the auxiliary capacitance 702 of each pixel may be adjusted such that the voltage output from the in-pixel readout circuit 203 of the first pixel equals that of the second pixel when uniform incident light irradiates the first photoelectric conversion element 202a and the second photoelectric conversion element 202b. In addition to this embodiment, the difference between the voltages output from the in-pixel readout circuits 203 may be reduced by adjusting their gains, as in the first embodiment.

According to this embodiment, the difference between the voltages output from the in-pixel readout circuits 203 is thus reduced for the pixels whose photoelectric conversion elements 202 have different areas on the planar view.

### Third Embodiment

This embodiment treats a case in which the photoelectric conversion elements have the same area on the planar view but different sensitivities. The components other than the photoelectric conversion elements are the same as in the first and second embodiments, and a description thereof will not be repeated. In the following explanation, electrons are used as signal charges. However, holes may be used. When using holes as signal charges, each semiconductor region has an opposite conductivity type.

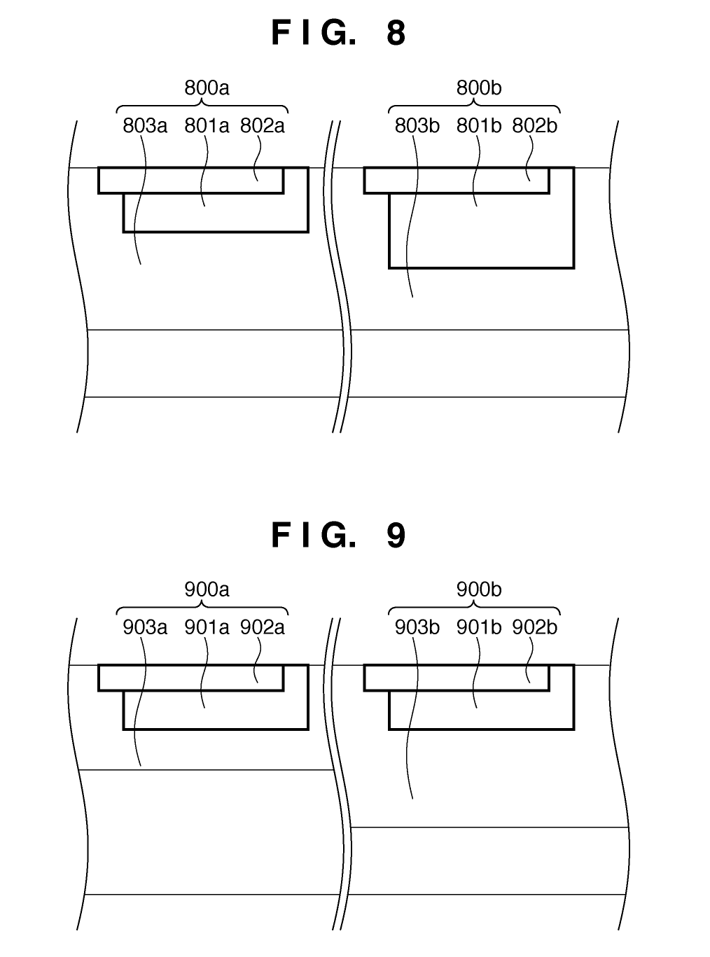

FIG. 8 explains the sectional structures of two photoelectric conversion elements 800a and 800b whose sensitivities are different from each other. A pixel array GA of a solid-state imaging apparatus according to this embodiment can include the two photoelectric conversion elements 800a and 800b whose sensitivities are different from each other.

The photoelectric conversion element 800a is, for example, a buried photodiode and can include an n-type semiconductor region 801a, a p-type semiconductor region 802a, and a p-type semiconductor region 803a. The p-type semiconductor region 802a is arranged on the surface side (light receiving side) of the n-type semiconductor region 801a so as to function as the region that suppresses the dark current generated on the semiconductor region side of the insulating film interface. The p-type semiconductor region 803a is arranged under the n-type semiconductor region 801a. The photoelectric conversion element 800b is, for example, a buried photodiode and can include an n-type semiconductor region 801b, a p-type semiconductor region 802b, and a p-type semiconductor region 803b. The photoelectric conversion element 800b can have the same structure as that of the photoelectric conversion element 800a.

In the two photoelectric conversion elements 800a and 800b, the p-type semiconductor regions 802a and 802b have the same impurity concentration distribution and are arranged up to the same depth. The p-type semiconductor regions 803a and 803b also have the same impurity concentration distribution and are arranged up to the same depth. However, the n-type semiconductor region 801b is arranged up to a position deeper than the n-type semiconductor region 801a. The photoelectric conversion element 800a more easily captures signal charges generated in a deep region than the photoelectric conversion element 800b because the n-type semiconductor region having the same polarity as that of the signal charges is arranged up to the deeper position. For this reason, the photoelectric conversion element 800b is more sensitive than the photoelectric conversion element 800a even if they have the same area on the planar view.

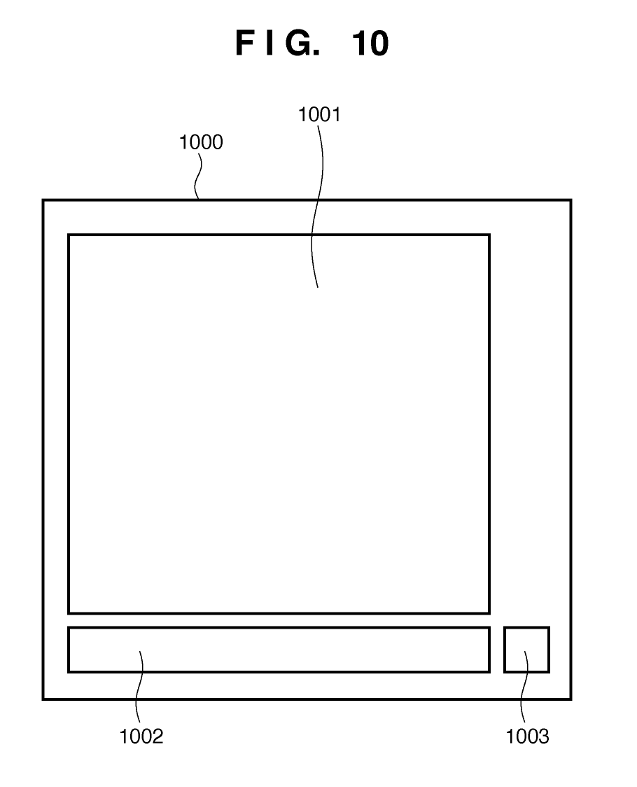

The photoelectric conversion elements can have different sensitivities even by the structural difference as shown in FIG. 9. A photoelectric conversion element 900a is, for example, a buried photodiode and can include an n-type semiconductor region 901a, a p-type semiconductor region 902a, and a p-type semiconductor region 903a. The p-type semiconductor region 902a is arranged on the surface side (light receiving side) of the n-type semiconductor region 901a so as to function as the region that suppresses the dark current generated on the semiconductor region side of the insulating film interface. The p-type semiconductor region 903a is arranged under the n-type semiconductor region 901a. A photoelectric conversion element 900b is, for example, a buried photodiode and can include an n-type semiconductor region 901b, a p-type semiconductor region 902b, and a p-type semiconductor region 903b. The photoelectric conversion element 900b can have the same structure as that of the photoelectric conversion element 900a.

In the two photoelectric conversion elements 900a and 900b, the n-type semiconductor regions 901a and 901b have the same impurity concentration distribution and are arranged up to the same depth. The p-type semiconductor regions 902a and 902b also have the same impurity concentration distribution and are arranged up to the same depth. However, the p-type semiconductor region 903b is arranged up to a position deeper than the p-type semiconductor region 903a. The photoelectric conversion element 900b more easily captures signal charges generated in a deep region than the photoelectric conversion element 900a because the p-type semiconductor region having the polarity opposite to as that of the signal charges is arranged up to the deeper position. This can be implemented by depleting the p-type semiconductor region 903b arranged up to the deep position to capture the signal charges or forming a potential structure that allows the signal charges to readily gather in the n-type semiconductor region 901b. For this reason, the photoelectric conversion element 900b is more sensitive than the photoelectric conversion element 900a even if they have the same area on the planar view.

As described above, even when the sensitivity changes depending on the structural difference between the photoelectric conversion elements, the difference in sensitivity can be suppressed by adjusting the gain or the like, as in the first and second embodiments. The factors that change the sensitivity as described in the first to third embodiments may be combined. That is, the area of the photoelectric conversion element on the planar view may be changed, and simultaneously, the depth of the n-type semiconductor region or the p-type semiconductor region may be changed. The actual sensitivity may also change depending on, for example, the transfer efficiency upon reading out the charges generated in the photoelectric conversion element to the readout circuit. That is, the gain or the like is adjusted to reduce the difference in signal charges that reach the readout circuit when uniform incident light irradiates the photoelectric conversion elements.

### Fourth Embodiment

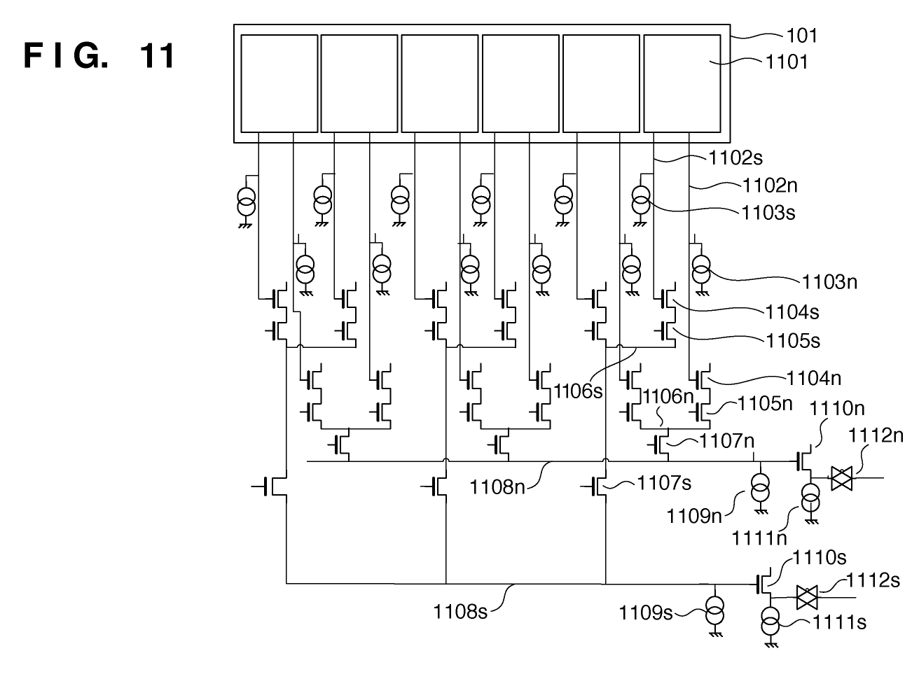

A solid-state imaging apparatus according to this embodiment will be described with reference to FIG. 10. The solid-state imaging apparatus of this embodiment is different from that of the first embodiment in that an imaging block 1000 is used in place of the imaging block 101. A description of the same parts as in the first embodiment will not be repeated. The imaging block 1000 is different from the imaging block 101 in the place where the amplifier circuit that changes the gain is arranged.

The imaging block 1000 can include a pixel array 1001, a column parallel processing circuit unit 1002, and an output unit 1003. The pixel array 1001 includes pixels arranged in a matrix. A vertical scanning circuit selects a predetermined pixel row to almost simultaneously read out signals to corresponding vertical output lines. The column parallel processing circuit unit 1002 can parallelly process signals output to the plurality of vertical output lines. The output unit 1003 sequentially receives signals processed by the column parallel processing circuit unit 1002 via a horizontal scanning circuit and converted into a serial output. Each of the column parallel processing circuit unit 1002 and the output unit 1003 can include an amplifier circuit such as an operational amplifier.

The imaging block 1000 can change the gain of the amplifier circuit that can be included in each of the column parallel processing circuit unit 1002 and the output unit 1003 by the signal from a control circuit (not shown), amplify the signal from the first pixel having the first photoelectric conversion element with a low sensitivity by a first gain, and amplify the signal from the second pixel having the second photoelectric conversion element with a sensitivity higher than that of the first photoelectric conversion element by the second gain smaller than the first gain. In this case, each pixel can have an amplifier circuit or not. When each pixel has an amplifier circuit, the gain can appropriately be set by the plurality of amplifier circuits in the pixel, the column parallel processing circuit unit 1002, and the output unit 1003.

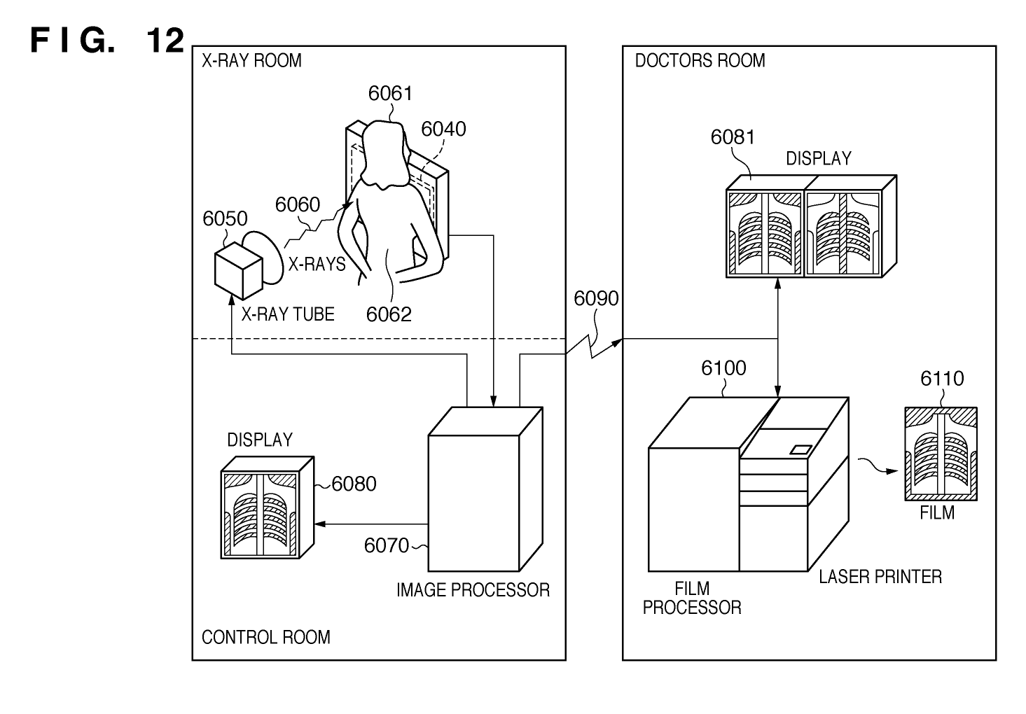

Another example of the arrangement of the imaging block 101 will be described with reference to FIG. 11. FIG. 11 is a conceptual diagram of an equivalent circuit of each imaging block 101. The imaging area of each imaging block 101 has a plurality of columns 1101. Each column 1101 has a plurality of pixels corresponding to a plurality of rows, respectively. Each pixel can have various arrangements and, for example, the arrangement shown in FIG. 3.

In accordance with a driving pulse supplied from the horizontal scanning circuit (not shown), the signal of each row is sequentially output to the vertical signal line. The signals of the plurality of pixels included in each row can simultaneously be output to the corresponding vertical signal lines. A constituent element denoted by a reference numeral with a suffix “s” handles a light signal on which a noise signal is superimposed (to be simply referred to as a light signal hereinafter). A constituent element denoted by a reference numeral with a suffix “n” handles a noise signal generated in the pixel. For example, a vertical signal line 1102s transmits a light signal, and a vertical signal line 1102n transmits a noise signal generated in the pixel. When time-divisionally reading out the light signal and the noise signal, only one vertical signal line suffices for each column. When each pixel includes an amplifier circuit, current sources 1103s and 1103n supply bias currents to the amplifier circuits. As the amplifier circuit, for example, a source follower circuit can be used.

Column amplifier circuits 1104s and 1104n are provided in correspondence with the vertical signal lines 1102s and 1102n, respectively. In this arrangement example, the column amplifier circuits 1104s and 1104n are source follower circuits. Select switches 1105s and 1105n are set active sequentially or at random by a driving pulse supplied from the horizontal scanning circuit (not shown). Block horizontal signal lines 1106s and 1106n are provided while electrically isolated for every plurality of columns included in the block. Signals from the plurality of columns of the block can be read out to the block horizontal signal lines 1106s and 1106n. Reference numerals 1107s and 1107n denote block select switches. The signals read out to the block horizontal signal lines 1106s and 1106n are read out to horizontal signal lines 1108s and 1108n by setting the block select switches 1107s and 1107n active sequentially or at random. The block select switches 1107s and 1107n can be controlled by the driving pulse from the horizontal scanning circuit (not shown). In this arrangement example, the block horizontal signal lines 1106s and 1106n and the horizontal signal lines 1108s and 1108n are directly driven by the column amplifier circuits 1104s and 1104n that are source follower circuits. The column amplifier circuits 1104s and 1104n drive the block horizontal signal lines 1106s and 1106n and the horizontal signal lines 1108s and 1108n based on the signals read out to the vertical signal lines 1102s and 1102n.

Current sources 1109s and 1109n supply bias currents to the column amplifier circuits 1104s and 1104n. The current sources 1109s and 1109n supply the currents to the column amplifier circuits 1104s and 1104n via the horizontal output lines 1108s and 1108n, the block select switches 1107s and 1107n, the block horizontal signal lines 1106s and 1106n, and the select switches 1105s and 1105n. Hence, the column amplifier circuits 1104s and 1104n corresponding to the column selected by the horizontal scanning circuit (not shown) drive the block horizontal signal lines 1106s and 1106n and the horizontal signal lines 1108s and 1108n. Amplifier circuits 1110s and 1110n are arranged on the electrical paths between the horizontal signal lines 1108s and 1108n and an output pad (not shown). In the arrangement example shown in FIG. 11, the amplifier circuits 1110s and 1110n are source followers. The signals amplified by the amplifier circuits 1110s and 1110n are output via the output pad, and a signal processing IC of the succeeding stage performs signal processing such as A/D conversion. A common signal processing IC may be provided for a plurality of imaging blocks 101, or a plurality of signal processing ICs may be provided for each imaging block 101 or a predetermined number of imaging blocks 101. Current sources 1111s and 1111n supply bias currents to the amplifier circuits 1110s and 1110n. Reference numerals 1112s and 1112n denote chip select switches.

In such an imaging apparatus, the signal readout is performed in accordance with the following sequence. Signals of a predetermined row are read out to corresponding vertical signal lines almost simultaneously in accordance with the driving pulse from the vertical scanning circuit (not shown). After that, the signals read out to the plurality of vertical signal lines are sequentially read out to the horizontal signal lines via the block horizontal signal lines in accordance with the driving pulse from the horizontal scanning circuit (not shown). In such an arrangement, the plurality of signals are parallelly read out to the vertical signal lines and then serially converted when output to the horizontal output line. In this arrangement, the speed upon serially converting and reading out the signals sometimes determines the readout speed of the signals of the entire image. At this time, if the imaging block is long in the row direction, the resistance and load of the horizontal output line increase, resulting in disadvantage from the viewpoint of the speed. Especially when the amplifier circuits provided on the columns directly drive the horizontal output lines, as in the arrangement of FIG. 11, the resistance and load of the horizontal output line particularly affect the speed.

According to the arrangement in FIG. 11, the gain can be adjusted by column amplifier circuits 1104s and 1104n or amplifier circuits 1100s and 1100n.

<Application to Radiation Imaging System>

FIG. 12 illustrates an example in which the solid-state imaging apparatus according to the present invention is applied to an X-ray diagnostic system (radiation imaging system). The radiation imaging system includes a radiation imaging apparatus 6040 and an image processor 6070 which processes a signal output from the radiation imaging apparatus 6040. The radiation imaging apparatus 6040 serves as an apparatus to which the solid-state imaging apparatus 100 mentioned above is applied so as to capture radiation as illustrated in FIG. 1B. X-rays 6060 emitted by an X-ray tube (radiation source) 6050 are transmitted through a chest 6062 of a patient or a subject 6061, and enter the radiation imaging apparatus 6040. The incident X-rays bear the information of the interior of the body of the subject 6061. The image processor (processor) 6070 processes a signal (image) output from the radiation imaging apparatus 6040, and can display the image on, for example, a display 6080 in a control room based on the signal obtained by processing.

Also, the image processor 6070 can transfer the signal obtained by processing to a remote site via a transmission path 6090. This makes it possible to display the image on a display 6081 placed in, for example, a doctor room at another site or record the image on a recording medium such as an optical disk. The recording medium may be a film 6110, and a film processor 6100 records the image on the film 6110 in this case.

The solid-state imaging apparatus according to the present invention is also applicable to an imaging system which captures an image of visible light. Such an imaging system can include, for example, the solid-state imaging apparatus 100 and a processor which processes a signal output from the solid-state imaging apparatus 100. The processing by the processor can include at least one of, for example, processing of converting the image format, processing of compressing the image, processing of changing the image size, and processing of changing the image contrast.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2010-155262 filed Jul. 7, 2010 and No. 2011-136973 filed Jun. 21, 2011, which are hereby incorporated by reference herein in their entirety.

What is claimed is:

1. A solid-state imaging apparatus including a plurality of pixels each having a photoelectric conversion element, and an amplifier circuit which amplifies and outputs signals of the plurality of pixels,
the plurality of pixels comprising a first pixel having a first photoelectric conversion element with a first sensitivity and a second pixel having a second photoelectric conversion element with a second sensitivity higher than the first sensitivity,
wherein the amplifier circuit amplifies a signal output from the first pixel by a first gain and a signal output from the second pixel by a second gain smaller than the first gain.

2. The apparatus according to claim 1, wherein an area of the first photoelectric conversion element on a planar view is smaller than an area of the second photoelectric conversion element on the planar view.

3. The apparatus according to claim 1, further comprising a scanning circuit configured to scan the signals output from the plurality of pixels,
wherein the first pixel is adjacent to the scanning circuit, and the second pixel is not adjacent to the scanning circuit.

4. The apparatus according to claim 1, wherein the amplifier circuit is included in each pixel.

5. An imaging system comprising:
a solid-state imaging apparatus according to claim 1; and
a processor configured to process a signal output from the solid-state imaging apparatus.

6. A solid-state imaging apparatus including a plurality of pixels each having a photoelectric conversion element and an auxiliary capacitance connected to the photoelectric conversion element to increase a capacitance value of the photoelectric conversion element, and an amplifier circuit which amplifies and outputs signals of the plurality of pixels,
the plurality of pixels comprising a first pixel having a first photoelectric conversion element with a first sensitivity and a second pixel having a second photoelectric conversion element with a second sensitivity higher than the first sensitivity,
wherein a capacitance value of the auxiliary capacitance connected to the first photoelectric conversion element is smaller than a capacitance value of the auxiliary capacitance connected to the second photoelectric conversion element.

7. The apparatus according to claim 6, wherein an area of the first photoelectric conversion element on a planar view is smaller than an area of the second photoelectric conversion element on the planar view.

8. The apparatus according to claim 6, further comprising a scanning circuit configured to scan the signals output from the plurality of pixels,
wherein the first pixel is adjacent to the scanning circuit, and the second pixel is not adjacent to the scanning circuit.

9. An imaging system comprising:
a solid-state imaging apparatus according to claim 6; and
a processor which processes a signal output from the solid-state imaging apparatus.
